(19) United States
(12) Patent Application Publication
(10) Pub. No.: US 2026/0342127 A1
(43) Pub. Date: Oct. 29, 2026

(54) ENERGY STORAGE POWER SUPPLY AND HOUSEHOLD LOAD BACKUP POWER SYSTEM

(71) Applicant: SHENZHEN HELLO TECH ENERGY CO., LTD, Shenzhen (CN)

(72) Inventors: Yuanchi YANG, Shenzhen (CN); Junhao CHEN, Shenzhen (CN); Xiaoping WANG, Shenzhen (CN)

(21) Appl. No.: 19/716,169

(22) Filed: Jun. 23, 2026

Related U.S. Application Data
(63) Continuation of application No. PCT/CN2025/148226, filed on Dec. 31, 2025.

(51) Int. Cl. H02J 9/06; H01M 10/42; H01M 50/247; H02J 3/0014; H02J 3/08; H02J 3/175; H02J 3/32; H02J 7/04; H02J 7/44; H02J 7/62; H02J 7/90; H02J 101/24; H02J 105/12; H02J 105/42

(52) U.S. Cl. CPC H02J 9/063; H01M 10/425; H01M 50/247; H02J 3/00142; H02J 3/08; H02J 3/175; H02J 3/32; H02J 7/04; H02J 7/44; H02J 7/62; H02J 7/933; H01M 2010/4271; H02J 2101/24; H02J 2105/12; H02J 2105/42; H02J 2207/20

(57) ABSTRACT

An energy storage power supply and a household load backup power system of the present disclosure are provided. The energy storage power supply includes a transfer switch circuit. The transfer switch circuit includes a utility power input terminal connected to an alternating-current input interface, an inverter alternating-current terminal connected to a battery pack, and a load output terminal connected to an alternating-current output interface. When utility power is abnormal, a connection between the inverter alternating-current terminal and the load output terminal is controlled to be enabled.

### CROSS-REFERENCE TO RELATED APPLICATION

This application is a continuation of International Application No. PCT/CN2025/148226, filed on Dec. 31, 2025, the entire contents of which are incorporated herein by reference.

### FIELD

The present disclosure relates to the technical field of energy storage devices, and more particularly, to an energy storage power supply and a household load backup power system.

### BACKGROUND

With the rapid iteration of new energy technologies and the continuous growth of outdoor economy and emergency support requirements, mobile energy storage power supplies are widely used in scenarios such as household backup power, outdoor camping electricity, and emergency rescue power supply, due to their flexible mobility, cleanliness, and environmental friendliness. In recent years, user requirements for capacities of the energy storage power supplies have shown a significant growth trend. In order to adapt to power supply requirements of high-power electrical appliances (such as a household refrigerator, an air conditioner, and an outdoor construction device), large-capacity mobile energy storage power supplies have emerged on the market, such as mobile energy storage power supplies with capacities of 3 kWh, 4 kWh, and 5 kWh. Such large-capacity mobile energy storage power supplies are now capable of satisfying requirements for medium-and short-term emergency power and household backup power supplies.

However, during household emergency backup power supply, in the event of a utility power outage, a user needs to manually switch the electrical appliance from a wall socket to the energy storage power supply. This operation is inconvenient and fails to achieve uninterrupted power supply. Currently, in order to achieve automatic millisecond-level switching of a load during the power outage, it is necessary to equip a smart backup power device, also referred to as a Smart Transfer Switch (STS) device or an Automatic Transfer Switch (ATS) device, to be used in conjunction with the mobile energy storage power supply. This device can monitor a state of utility power in real time. When the utility power is normal, power is supplied by the utility power. When the utility power is abnormal, the load is automatically switched to be powered by the energy storage power supply, thereby ensuring continuous operation of a key electrical appliance.

However, the inventor has realized that as a key electrical switching component, the STS device integrates a high-precision detection module, a high-speed switching actuating mechanism, and a complex control circuit internally, resulting in a persistently high device cost. In addition, mounting of the STS device also requires modification of an original household circuit, to rewire a load line to the device. This involves extensive mounting work and requires a professional electrician, which further raises a threshold for use. The high cost and complex mounting of the STS device restrict promotion of the mobile energy storage power supply in a household emergency backup power scenario.

### SUMMARY

An embodiment of the present disclosure provides an energy storage power supply and a household load backup power system to solve at least one of technical problems mentioned above.

An energy storage power supply according to an embodiment of the present disclosure includes: a housing; an alternating-current input interface and an alternating-current output interface that are formed at the housing, in which the alternating-current input interface is configured to be in a pluggable connection with a utility power socket through a first pluggable connector, the utility power socket being connected to utility power, and in which the alternating-current output interface is configured to be in a pluggable connection with a backup power device through a second pluggable connector, the backup power device being configured to be connected to an alternating-current load; and a battery pack, an inverter, a controller, and a transfer switch circuit that are disposed in the housing. The transfer switch circuit includes a utility power input terminal, an inverter alternating-current terminal, and a load output terminal. The utility power input terminal is connected to the alternating-current input interface, the inverter alternating-current terminal is connected to the battery pack through the inverter, and the load output terminal is connected to the alternating-current output interface. The controller is configured to: monitor utility power voltage information at the utility power input terminal; control, in response to the utility power voltage information being normal, the transfer switch circuit to enable a connection between the utility power input terminal and the load output terminal, to cause the utility power, after passing through the alternating-current input interface and the alternating-current output interface, to supply power to the alternating-current load connected to the backup power device; and control, in response to the utility power voltage information being abnormal, the transfer switch circuit to enable a connection between the inverter alternating-current terminal and the load output terminal, to cause the battery pack, after DC power from the battery pack being inverted to AC power by the inverter, to supply power to the alternating-current load connected to the backup power device.

In the energy storage power supply provided by the present disclosure, the transfer switch circuit is integrated and built into the housing, i.e., inside the energy storage power supply, and is already connected to the battery pack, the alternating-current input interface, and the alternating-current output interface. Compared with an existing external ATS, it is only necessary to connect the utility power socket and the alternating-current input interface through the first pluggable connector, and then connect the alternating-current output interface and the backup power device through the second pluggable connector. A household core load, such as a refrigerator, is connected to the backup power device and powered by the backup power device. In this way, the transfer switch circuit is connected to the battery pack, the utility power, and the household core load. The utility power socket and the backup power device are original devices of a household circuit. Therefore, there is no need to change an original household circuit, nor is there a need for a professional technician to mount it. In this way, the energy storage power supply can be used as a household backup power supply, and a mounting cost is also low. Finally, during operation, the inverter is capable of detecting a voltage at the utility power input terminal, and controlling the transfer switch circuit to enable a connection between the battery pack and the household core load when the voltage is abnormal, thereby achieving uninterrupted power supply and ensuring stable operation of the household core load.

Additional aspects and advantages of the embodiments of the present disclosure will be provided in part in the following description, or will become apparent in part from the following description, or can be learned from practicing of the embodiments of the present disclosure.

### BRIEF DESCRIPTION OF THE DRAWINGS

In order to clearly explain technical solutions of embodiments of the present disclosure, drawings used in the description of the embodiments are briefly described below. Obviously, the drawings as described below are merely some embodiments of the present disclosure. Based on these drawings, other drawings can be obtained by those skilled in the art without creative effort.

FIG. 1 is a schematic circuit diagram of a household load backup power system according to an embodiment of the present disclosure;

FIG. 2 is a schematic structural diagram of an energy storage power supply according to an embodiment of the present disclosure;

FIG. 3 is a schematic diagram illustrating a connection of an energy storage power supply with a utility power socket and a backup power device according to an embodiment of the present disclosure;

FIG. 4 is a schematic diagram illustrating a connection between an energy storage power supply and a backup power device according to an embodiment of the present disclosure; and

FIG. 5 is a schematic circuit diagram of a household load backup power system according to an embodiment of the present disclosure.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure. In th description of the present disclosure, it needs to be understood that, orientations or positional relationships indicated by terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “counterclockwise”, etc., are based on the orientation or position relationship shown in the drawings, and are only for the convenience of describing the present disclosure and simplifying the description, rather than indicating or implying that the associated device or element must have a specific orientation, or be constructed and operated in a specific orientation, and therefore cannot be understood as a limitation to the present disclosure. In the description of the present disclosure, “plurality” means at least two, unless otherwise specifically defined.

In the present disclosure, it should be noted that, unless otherwise clearly specified and limited, terms such as “mount”, “connect”, “connect to”, and the like should be understood in a broad sense. For example, it may be a fixed connection or a detachable connection or an integral connection as one piece; a mechanical connection or an electrical connection; a direct connection or an indirect connection through an intermediate; or internal communication of two components or the interaction relationship between two components. For those of ordinary skill in the art, the specific meaning of the above terms in the present disclosure can be understood according to specific circumstances.

In the present disclosure, unless expressly stipulated and defined otherwise, the first feature “on” or “under” the second feature may include that the first feature is in direct contact with the second feature, or include that the first and second features are in indirect contact through another feature between the first and second features. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the first feature is at a lower level than the second feature.

Various embodiments or examples for implementing different structures of the present disclosure are provided below. In order to simplify the description of the present disclosure, components and configurations of specific examples are described below. Of course, these specific examples are merely for the purpose of illustration, rather than limiting the present disclosure. Further, the same reference numerals and/or reference letters may appear in different examples of the present disclosure for the purpose of simplicity and clarity, instead of indicating a relationship between different embodiments and/or the discussed configurations. In addition, the present disclosure provides examples of various specific processes and materials. However, applications of other processes and/or the use of other materials are conceivable for those of ordinary skill in the art.

Referring to FIG. 1 to FIG. 4, the present disclosure provides a household load backup power system 1000. The household load backup power system 1000 includes an energy storage power supply 100. The energy storage power supply 100 includes a housing 10, an alternating-current input interface 12 and an alternating-current output interface 13 that are formed at the housing 10, and a battery pack 20, an inverter 30, a controller 31, and a transfer switch circuit 40 that are disposed in the housing 10. The alternating-current input interface 12 is configured to be in a pluggable connection with a utility power socket 200 through a first pluggable connector 60, and the utility power socket 200 is connected to utility power. The alternating-current output interface 13 is configured to be in a pluggable connection with a backup power device 300 through a second pluggable connector 70, and the backup power device 300 is configured to be connected to an alternating-current load. The transfer switch circuit 40 includes a utility power input terminal 41, an inverter alternating-current terminal 42, and a load output terminal 43. The utility power input terminal 41 is connected to the alternating-current input interface 12. The inverter alternating-current terminal 42 is connected to the battery pack 20 through the inverter 30, and the load output terminal 43 is connected to the alternating-current output interface 13. The controller 31 is configured to: monitor utility power voltage information at the utility power input terminal 41; control, in response to the utility power voltage information being normal, the transfer switch circuit 40 to enable a connection between the utility power input terminal 41 and the load output terminal 43, to cause the utility power, after passing through the alternating-current input interface 12 and the alternating-current output interface 13, to supply power to the alternating-current load connected to the backup power device 300; and control, in response to the utility power voltage information being abnormal, the transfer switch circuit 40 to enable a connection between the inverter alternating-current terminal 42 and the load output terminal 43, to cause the battery pack 20, after DC power from the battery pack being inverted to AC power by the inverter 30, to supply power to the alternating-current load connected to the backup power device 300.

In the energy storage power supply 100 provided by the present disclosure, the transfer switch circuit 40 is integrated and built into the housing 10, i.e., inside the energy storage power supply 100. The transfer switch circuit 40 is already connected to the battery pack 20, the alternating-current input interface 12, and the alternating-current output interface 13. Compared with an existing external STS/ATS, it is only necessary to connect the utility power socket 200 and the alternating-current input interface 12 through the first pluggable connector 60, and then connect the alternating-current output interface 13 and the backup power device 300 through the second pluggable connector 70. A household core load, such as a refrigerator, is connected to the backup power device 300 and obtains power through the backup power device 300. In this way, the transfer switch circuit 40 is connected to the battery pack 20, the utility power, and the household core load. The utility power socket 200 and the backup power device 300 are original devices of a household circuit. Therefore, there is no need to change an original household circuit, nor is there a need for a professional technician to mount the energy storage power supply. In this way, the energy storage power supply 100 can be used as a household backup power supply, and a mounting cost is also low. Finally, during operation, the inverter 30 is capable of detecting a voltage at the utility power input terminal 41, and controlling the transfer switch circuit 40 to connect the battery pack 20 and the household core load when the voltage is abnormal, thereby achieving uninterrupted power supply and ensuring stable operation of the household core load.

Specifically, the energy storage power supply 100 is a mobile energy storage power supply 100, which generally includes two types: a portable energy storage power supply 100 and a balcony photovoltaic energy storage power supply 100. In the embodiment of the present disclosure, the portable energy storage power supply 100 is taken as an example for description.

In the embodiment of the present disclosure, the housing 10 is made of a high-strength engineering plastic material. Its surface has a regular opening formed as required for mounting the alternating-current input interface 12 and the alternating-current output interface 13 in an embedded manner. A sealing rubber ring is provided at edges of the interfaces to improve dustproof and waterproof performance. A mounting support is fixed inside the housing 10 by bolts. The battery pack 20, the inverter 30, and the transfer switch circuit 40 are each mounted and fixed through the respective support.

The transfer switch circuit 40 is built into the housing 10 and completes a pre-connection with other components. In actual mounting, it is only necessary to connect the utility power socket 200 to the alternating-current input interface 12 through the first pluggable connector 60. The utility power socket 200 may be a wall socket or a socket in another form. Moreover, the alternating-current output interface 13 is connected to the backup power device 300 through the second pluggable connector 70. The household core load (such as a refrigerator or an air conditioner) is fixedly connected to an output terminal of the backup power device 300 through a wire.

In the embodiment of the present disclosure, the controller 31 of the inverter 30 is electrically connected to a control terminal of the transfer switch circuit 40 through a power grid tracking module, and monitors the utility power voltage information at the utility power input terminal 41 in real time. The utility power voltage information includes, but is not limited to, voltage amplitude information and voltage frequency information.

In the embodiment of the present disclosure, in response to the utility power voltage information being normal, the controller 31 outputs a control signal to drive a switching element inside the transfer switch circuit 40 to operate, enabling the connection between the utility power input terminal 41 and the load output terminal 43. At this time, the utility power sequentially passes through the utility power socket 200, the first pluggable connector 60, the alternating-current input interface 12, the transfer switch circuit 40, the alternating-current output interface 13, the second pluggable connector 70, and the backup power device 300, to supply power to the alternating-current load. In response to the utility power voltage information being abnormal, the controller 31 responds quickly and drives the transfer switch circuit 40 to switch to a state where the connection between the inverter alternating-current terminal 42 and the load output terminal 43 is enabled. A direct current stored in the battery pack 20 is inverted into an alternating current by the inverter 30, and then passes through the transfer switch circuit 40, the alternating-current output interface 13, the second pluggable connector 70, and the backup power device 300, to supply power to the alternating-current load. The entire switching process has a short response time, and is capable of achieving the uninterrupted power supply and ensuring the stable operation of the household core load.

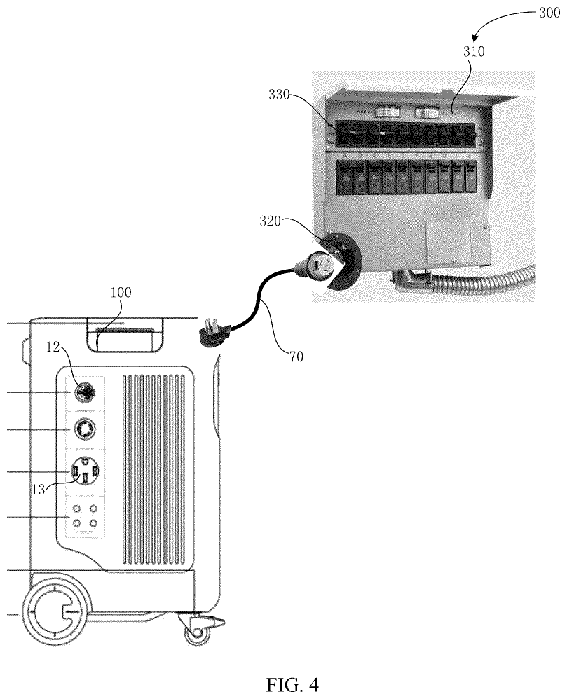

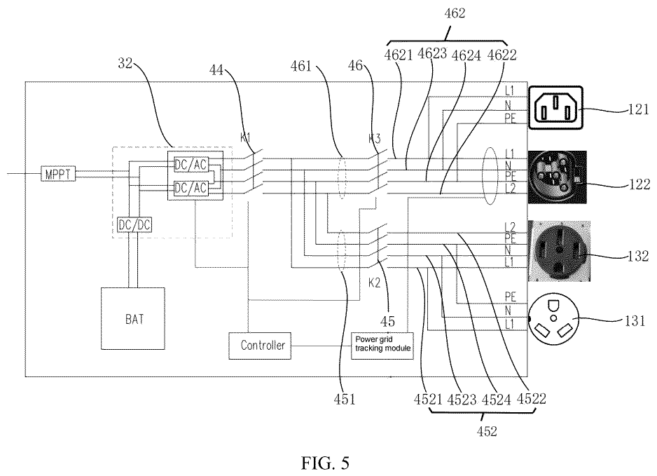

Referring to FIG. 4, in some embodiments, the backup power device 300 includes a manual transfer switch backup power device 310, and the alternating-current output interface 13 is configured to be in a pluggable connection with a power receiving socket 320 of the manual transfer switch backup power device 310 through the second pluggable connector 70.

In this way, by adopting the manual transfer switch backup power device 310 and connecting it to the energy storage power supply 100 through the pluggable connector, the adaptation of a low-cost and high-reliability backup power solution is realized, which is conducive to reducing purchase and maintenance costs of the entire household backup power system, and facilitates user self-mounting and wiring, further lowering a threshold for use.

Specifically, in the embodiment of the present disclosure, the backup power device 300 includes a manual transfer switch backup power device 310. The manual transfer switch (MTS) backup power device 310 is a device used in conjunction with a diesel generator, specifically a manual transfer switch that controls whether the utility power or the diesel generator supplies power. A standard operating mode of the manual transfer switch backup power device 310 defaults to connection to a utility power side, with the utility power supplying power to the alternating-current load by default. Only upon a utility power failure, the user manually starts the generator and operates the switch to switch to a backup power side. The backup power is usually a fuel generator, thereby realizing a backup power supply mode of “manual restoration after power outage”.

In the embodiment of the present disclosure, the power receiving socket 320 is mounted on a surface of the housing 10 of the manual transfer switch backup power device 310 in an embedded manner. The power receiving socket 320 adopts a standardized socket design matching the second pluggable connector 70. The alternating-current output interface 13 of the energy storage power supply 100 forms a detachable electrical connection with the power receiving socket 320 of the manual transfer switch backup power device 310 through the second pluggable connector 70.

Referring to FIG. 4, in some embodiments, the manual transfer switch backup power device 310 includes a power supply selection switch 330. The power supply selection switch 330 includes a backup-power supply operation position, and is configured to be in the backup-power supply operation position by default to enable a connection between the energy storage power supply 100 and the backup power device.

In this way, by connecting the utility power to the backup power device through the energy storage power supply 100, once the utility power fails, an automatic transfer switch inside the energy storage power supply 100 immediately operates within milliseconds to cut off a utility power path, thereby achieving seamless switching of power supply and ensuring the stable operation of the household core load.

Specifically, in some embodiments, the power supply selection switch 330 of the manual transfer switch backup power device 310 is provided with a backup-power supply operation position and a utility-power supply operation position. In the case where the power supply selection switch 330 is in the utility-power supply operation position, the utility power is directly connected to the backup power device 300. In the case where the power supply selection switch 330 is in the backup-power supply operation position, the energy storage power supply 100 is connected to the backup power device 300.

In the embodiment of the present disclosure, the energy storage power supply 100 is used in conjunction with the manual transfer switch backup power device 310, and the power supply selection switch 330 is set by default to the backup-power supply operation position. When the utility power is normal, the utility power is directly and efficiently supplied to the backup power device 300 through a high-current bypass channel inside the energy storage power supply 100. At this time, the energy storage power supply 100 may be used as a smart junction box. Once the utility power fails, the transfer switch circuit 40 inside the energy storage power supply 100 may operate within milliseconds to cut off the utility power path and seamlessly switch to a mode where the battery pack 20 supplies power to a load connected to the MTS through the inverter 30. For the user and an external MTS, since the MTS is always engaged on a backup power supply side, this entire process is completely automatic and imperceptible.

Referring to FIG. 1 and FIG. 5, in some embodiments, the inverter 30 includes a bidirectional alternating-current/direct-current converter 32 and a controller 31 connected to the bidirectional alternating-current/direct-current converter 32. The transfer switch circuit 40 includes a first relay 44, a second relay 45, and a third relay 46. The utility power input terminal 41 is connected to the bidirectional alternating-current/direct-current converter 32 sequentially through the third relay 46 and the first relay 44. The load output terminal 43 is connected to the bidirectional alternating-current/direct-current converter 32 sequentially through the second relay 45 and the first relay 44. The controller 31 is connected to the first relay 44, the second relay 45, and the third relay 46, and is configured to control closing and opening of each of the first relay 44, the second relay 45, and the third relay 46.

In the embodiment of the present disclosure, the number of bidirectional alternating-current/direct-current converters 32 is two. The two bidirectional alternating-current/direct-current converters 32 are connected in parallel to adapt to split-phase output. When only single-phase output is required, only one bidirectional alternating-current/direct-current converter 32 needs to operate.

In the embodiment of the present disclosure, a DC/DC circuit is further connected between the bidirectional alternating-current/direct-current converter 32 and the battery pack 20. When the battery pack 20 is being charged, the DC/DC circuit is capable of stepping down a high voltage from the bidirectional alternating-current/direct-current converter 32 to a low voltage suitable for the battery pack 20, and performing constant-current charging management or constant-voltage charging management for the battery. During discharging, the DC/DC circuit is also capable of stepping up a relatively low voltage outputted by the battery pack 20 to a high voltage matching the bidirectional alternating-current/direct-current converter 32, so that energy can flow out through the bidirectional alternating-current/direct-current converter 32.

In this way, by providing a circuit structure including the first switch and the second switch, automatic switching between the utility power and the battery pack 20 is realized, which is conducive to ensuring continuity and stability of the power supply and avoiding power interruption.

That is, in this embodiment, the controller 31 is a part of the inverter 30. In this way, the reuse of components can be realized, and the cost can be reduced. Of course, in other embodiments, the controller 31 may also be an independent device to achieve a better function.

Specifically, in the embodiment of the present disclosure, the bidirectional alternating-current/direct-current converter 32 internally includes components such as an IGBT power module, a filter inductor, and a capacitor. These components achieve circuit integration through a printed circuit board (PCB). The controller 31 adopts a microcontroller unit (MCU) or a digital signal processor (DSP) chip as a core control unit, is integrated on the same PCB, and forms an electrical connection with the power module of the bidirectional alternating-current/direct-current converter 32 through a copper foil line on the PCB.

In the embodiment of the present disclosure, the transfer switch circuit 40 includes a first relay 44, a second relay 45, and a third relay 46. The three relays are selected as electromagnetic relays, which have the capability to carry large currents, and are fixed on the mounting support inside the housing 10 of the energy storage power supply 100 through bolts. Contacts and coils of the relays are connected to corresponding components through wires, respectively.

The utility power input terminal 41 of the transfer switch circuit 40 is electrically connected to an alternating-current input terminal of the bidirectional alternating-current/direct-current converter 32 after being connected in series with the third relay 46 and the first relay 44 through wires in sequence. The load output terminal 43 is electrically connected to an alternating-current output terminal of the bidirectional alternating-current/direct-current converter 32 after being connected in series with the second relay 45 and the first relay 44 through wires in sequence.

In the embodiment of the present disclosure, a connection mode between the controller 31 and the first relay 44, the second relay 45, and the third relay 46 may be a wired connection or a wireless connection. High and low level signals outputted by the controller 31 are capable of controlling connection and disconnection of the coils of the relays, thereby controlling closing and opening of the contacts of the relays.

Referring to FIG. 5, in some embodiments, the controller 31 is further configured to control, in response to a utility power voltage being abnormal or a first predetermined condition being satisfied, the first relay 44 and the second relay 45 to be closed and the third relay 46 to be opened. The first predetermined condition includes that a current time period falls within a peak power consumption period of the utility power and that a state of charge (SOC) of the battery pack 20 is greater than or equal to a first predetermined value.

In this way, when the utility power is at the peak power consumption period and the battery pack 20 has sufficient power, the utility power is disconnected, and power is supplied only using the battery pack 20, which is conducive to reducing power consumption costs and improving energy economy.

Specifically, in the embodiment of the present disclosure, in response to the utility power voltage being abnormal or the first predetermined condition being satisfied, the controller 31 outputs the control signal to energize the coils of the first relay 44 and the second relay 45 to close the contacts, while de-energizing the coil of the third relay 46 to open the contacts. The first predetermined condition includes that the current time period falls within the peak power consumption period of the utility power and that the SOC of the battery pack 20 is greater than or equal to the first predetermined value. The peak power consumption period may be predetermined as 8:00~11:00 and 18:00~21:00 daily. The first predetermined value may be predetermined as 80% based on a capacity and performance of the battery pack 20.

Through this control logic, when the utility power is at the peak power consumption period and the battery pack 20 has sufficient power, the utility power is disconnected, and power is supplied only using the battery pack 20, which can avoid using high-priced utility power during the peak power consumption period, effectively reducing user's power consumption costs. Furthermore, electric energy stored in the battery pack 20 is reasonably utilized to improve the energy economy.

Referring to FIG. 5, in some embodiments, the controller 31 is further configured to control, in response to a second predetermined condition being satisfied, the first relay 44, the second relay 45, and the third relay 46 to be closed, to cause the battery pack 20 and the utility power to supply power to the alternating-current load simultaneously. The second predetermined condition includes that the current time period falls within the peak power consumption period of the utility power and that the SOC of the battery pack 20 is greater than a second predetermined value and smaller than the first predetermined value.

In this way, when the utility power is at the peak power consumption period and the battery pack 20 has insufficient power, power is supplied using both the utility power and the battery pack 20, which can avoid over-discharging the battery pack 20 and thus causing damage to the battery pack 20.

Specifically, in the embodiment of the present disclosure, the controller 31 is further configured to control, in response to the second predetermined condition being satisfied, the first relay 44, the second relay 45, and the third relay 46 to be closed simultaneously, to cause the battery pack 20 and the utility power to supply power to the alternating-current load simultaneously. The second predetermined condition includes that the current time period falls within the peak power consumption period of the utility power and that the SOC of the battery pack 20 is greater than the second predetermined value and smaller than the first predetermined value. The second predetermined value may be predetermined as 30% based on minimum protection power of the battery pack 20, and the first predetermined value is still 80%. At this time, the bidirectional alternating-current/direct-current converter 32 operates in a coordinated power supply state, and the controller 31 is capable of allocating a ratio of power supply of the utility power to power supply of the battery pack 20 based on a load power requirement and the SOC of the battery pack, ensuring that a discharging current of the battery pack 20 does not exceed a rated value.

For example, when load power is relatively high and the SOC of the battery pack 20 is around 50%, the utility power bears 60% of the load power, and the battery pack 20 bears 40% of the load power. When the load power is relatively low, a power supply ratio of the battery pack 20 can be appropriately reduced. Through this coordinated power supply mode, when the utility power is at the peak power consumption period and the battery pack 20 has insufficient power, not only can a power supply requirement of the load be satisfied, but the damage to the battery pack 20 caused by over-discharging is also avoided, thereby prolonging a service life of the battery pack 20. Meanwhile, compared with the scenario where the power is supplied entirely by the utility power, the power consumption cost can still be reduced to some extent.

In some embodiments, the controller 31 is further configured to obtain a voltage phase, an amplitude, and a frequency of the utility power, and control a phase difference between an output voltage of the bidirectional alternating-current/direct-current converter 32 and the utility power voltage not to exceed ±2°, an amplitude difference between the output voltage of the bidirectional alternating-current/direct-current converter 32 and the utility power voltage not to exceed ±10%, and a frequency difference between the output voltage of the bidirectional alternating-current/direct-current converter 32 and the utility power voltage not to exceed ±0.5 Hz.

In this way, by controlling the output voltage of the bidirectional alternating-current/direct-current converter 32 to achieve utility power tracking, intelligence of the energy storage power supply 100 is improved, which is conducive to reducing the user's power consumption cost.

Specifically, the controller 31 can obtain the voltage phase, amplitude, and frequency information of the utility power in real time through a voltage sampling circuit, and the voltage sampling circuit may be connected in parallel to the utility power input terminal 41 of the transfer switch circuit 40. The controller 31 controls the phase difference between the output voltage of the bidirectional alternating-current/direct-current converter 32 and the utility power voltage not to exceed ±2°, the amplitude difference between the output voltage of the bidirectional alternating-current/direct-current converter 32 and the utility power voltage not to exceed ±10%, and the frequency difference between the output voltage of the bidirectional alternating-current/direct-current converter 32 and the utility power voltage not to exceed ±0.5 Hz. In some embodiments, the phase difference controlled by the controller 31 between the output voltage of the bidirectional alternating-current/direct-current converter 32 and the utility power voltage may be ±1°. The amplitude difference controlled by the controller 31 between the output voltage of the bidirectional alternating-current/direct-current converter 32 and the utility power voltage may be ±8%, ±6%, ±4%, or ±2%. The frequency difference controlled by the controller 31 between the output voltage of the bidirectional alternating-current/direct-current converter 32 and the utility power voltage may be ±0.5 Hz, ±0.4 Hz, ±0.3 Hz, ±0.2 Hz, or ±0.1 Hz. In the embodiment of the present disclosure, the controller 31 should control the phases, amplitudes, and frequencies of the output voltage of the bidirectional alternating-current/direct-current converter 32 and the utility power voltage to be substantially the same, i.e., the phase difference between the output voltage of the bidirectional alternating-current/direct-current converter 32 and the utility power voltage is 0°, the amplitude difference between them may be 0%, and the frequency difference between them may be 0 Hz.

Through this high-precision utility power tracking, when the energy storage power supply 100 is in grid-connected power supply or during the switching process, it can be ensured that the output voltage of the bidirectional alternating-current/direct-current converter 32 highly matches the utility power voltage, avoiding an inrush current caused by an excessive difference in voltage parameters, and protecting a load device and components of the energy storage power supply 100 itself. In the coordinated power supply mode during the peak power consumption period of the utility power, smooth superposition of the power supply from the utility power and the battery pack 20 can be achieved. During a switching process when the utility power is about to be normal or become abnormal, the seamless switching can be achieved, preventing power interruption or voltage fluctuation from affecting the load. Meanwhile, a precise voltage adjustment is also conducive to improving charging efficiency of the battery pack 20. When charging is performed during a valley power consumption period of the utility power, the bidirectional alternating-current/direct-current converter 32 can be allowed to output a matched charging voltage, improving a charging speed and safety, and further reducing the user's power consumption cost.

In some embodiments, the controller 31 is further configured to obtain a voltage phase of the utility power and control a phase of an output voltage of the bidirectional alternating-current/direct-current converter 32 to lag the voltage phase of the utility power by a predetermined difference.

In this way, by setting the phase of the output voltage of the bidirectional alternating-current/direct-current converter 32 to lag behind the voltage phase of the utility power, a voltage difference is formed, thereby realizing that the current flows only from the utility power to the energy storage device, and avoiding power feeding.

Specifically, in the embodiment of the present disclosure, after obtaining the voltage phase of the utility power through the voltage sampling circuit, the controller 31 is capable of calculating a target phase of the output voltage of the bidirectional alternating-current/direct-current converter 32 through a built-in phase adjustment algorithm. The target phase lags the voltage phase of the utility power by a predetermined difference. The predetermined difference may be set based on a safety specification of the household circuit and a power level of the energy storage power supply 100, and is usually set to 5° to 10°.

This current flow direction control can effectively avoid a power grid voltage fluctuation caused by power feeding, complying with a safety specification of the household electricity, and can also prevent the electric energy of the energy storage power supply 100 from being lost without reason, ensuring rationality of energy utilization. Especially in a coordinated power supply mode of the utility power and the battery pack 20 or a charging mode during the valley period of the utility power, a current direction can be precisely controlled to ensure that the utility power is only used for power supply or charging, improving safety and stability of system operation.

In some embodiments, the controller 31 is in communication with the bidirectional alternating-current/direct-current converter 32 and configured to control output power of the bidirectional alternating-current/direct-current converter 32.

In this way, by enabling the controller 31 to be in communication with the bidirectional alternating-current/direct-current converter 32 and control its output power, precise adjustment and management of inverter output power of the energy storage power supply 100 are realized, which is conducive to dynamically adjusting a power supply capability according to load requirements, and facilitates realization of energy optimization control under different operating modes.

In some embodiments, the controller 31 establishes a communication connection with the bidirectional alternating-current/direct-current converter 32 to achieve precise adjustment and management of its output power, adapting to different load requirements and operating modes, and improving flexibility and rationality of energy utilization. Specifically, the controller 31 has a built-in power control algorithm, which calculates target output power of the bidirectional alternating-current/direct-current converter 32 based on parameters such as a current operating mode (like a backup power mode, a coordinated power supply mode, or a charging mode), the load power requirement, and the SOC of the battery, and transmits a power control instruction to the bidirectional alternating-current/direct-current converter 32 through a communication bus.

Further, the bidirectional alternating-current/direct-current converter 32 has a built-in power detection module, which detects its own output power in real time and feeds back actual power information to the controller 31 through the communication bus. The controller 31 adjusts the control instruction based on the feedback information, forming power closed-loop control.

For example, in the backup power mode, the output power can be dynamically adjusted based on an actual power requirement of the load, avoiding energy waste caused by power redundancy. In the coordinated power supply mode, power supplied by the utility power and the battery pack 20 can be precisely allocated to ensure power supply balance. In the charging mode, charging power can be adjusted based on the SOC of the battery to improve the charging efficiency and protect the battery. Meanwhile, the realization of the energy optimization control under different operating modes is facilitated, improving an intelligence level and energy economy of the entire household load backup power system 1000.

Referring to FIG. 5, in some embodiments, the controller 31 is further configured to control, in response to a current time period falling within a valley power consumption period of the utility power, the first relay 44, the second relay 45, and the third relay 46 to be closed, to cause the utility power to supply power to the battery pack 20 and the alternating-current load simultaneously.

In this way, when the utility power is at the valley period and the battery pack 20 has insufficient power, the utility power is used to supply power to the alternating-current load while charging the battery pack 20, which can avoid over-discharging the battery pack 20 and thus causing the damage to the battery pack 20.

Specifically, in the embodiment of the present disclosure, in response to the current time period falling within the valley power consumption period of the utility power, the controller 31 controls the three relays to be closed, to cause the utility power to supply power to the battery pack 20 and the alternating-current load simultaneously. Through this control mode, the battery pack 20 is charged using low-priced utility power during the valley period of the utility power, which can reduce a battery charging cost. Meanwhile, normal use of the load is not affected during the charging process, avoiding occupation of the power supply to the load during separate charging. In addition, compared with charging after the battery pack 20 is fully discharged, timely charging during the valley power consumption period can avoid over-discharging the battery pack 20, further protecting the battery pack 20 and prolonging its service life.

Referring to FIG. 5, in some embodiments, the controller 31 is in communication with the bidirectional alternating-current/direct-current converter 32, and further configured to control input power of the bidirectional alternating-current/direct-current converter 32 based on required power of the load.

In this way, by controlling the input power of the bidirectional alternating-current/direct-current converter 32 based on the required power of the load, an intelligent adjustment of the charging power of the battery when the utility power is supplied is realized, which is conducive to prioritizing continuity and stability of power supply to the load, and facilitates efficient and safe battery recharging during the valley power consumption period.

Specifically, in the embodiment of the present disclosure, in response to the current time period falling within the valley power consumption period of the utility power, the controller 31 prioritizes the power supply requirement of the load. When the load power is relatively large, charging power of the battery pack 20 is automatically reduced. When the load power is relatively small, the charging power is increased, ensuring that total consumption power of the utility power does not exceed a predetermined safety threshold.

For example, when the required power of the load suddenly increases, the controller 31 rapidly reduces the input power of the bidirectional alternating-current/direct-current converter 32 to prioritize ensuring that the load obtains sufficient power supply power. When the required power of the load decreases, the controller 31 gradually increases the input power to accelerate a charging speed of the battery pack 20. In this way, optimal allocation of electrical energy of the utility power is realized, which not only ensures the continuity and stability of the power supply to the load, but also charges the battery pack 20 at maximum safe power while ensuring the allowable range of the load power, improving the charging efficiency.

Referring to FIG. 5, in some embodiments, the alternating-current input interface 12 includes a single-phase alternating-current input interface 121 and a split-phase alternating-current input interface 122. The third relay 46 includes a first movable contact 461 and a first stationary contact 462. The first movable contact 461 is connected to both the first relay 44 and the second relay 45. The first stationary contact 462 includes a first L1 contact 4621, a first L2 contact 4622, a first neutral contact 4623, and a first ground contact 4624. The first L1 contact 4621 is connected to both a live wire of the single-phase alternating-current input interface 121 and an L1 live wire of the split-phase alternating-current input interface 122. The first L2 contact 4622 is connected to an L2 live wire of the split-phase alternating-current input interface 122. The first neutral contact 4623 is connected to both a neutral wire of the single-phase alternating-current input interface 121 and a neutral wire of the split-phase alternating-current input interface 122. The first ground contact 4624 is connected to both a ground wire of the single-phase alternating-current input interface 121 and a ground wire of the split-phase alternating-current input interface 122.

In this way, by specifically defining wiring modes of the single-phase alternating-current output interface 13, the single-phase alternating-current input interface, and the split-phase alternating-current output interface, and the split-phase alternating-current input interface, flexible adaptation of the device to single-phase utility power and split-phase utility power is realized, which facilitates mounting and use in different power environments.

Specifically, in the embodiment of the present disclosure, the movable contact and the stationary contact are two metal contact points inside the relay responsible for connecting or disconnecting the circuit. The movable contact is a contact component in the relay or a functional electrical appliance that realizes connection and disconnection of the circuit through mechanical displacement, while the stationary contact is a fixed contact component that does not move with action of an actuating mechanism.

In some embodiments, the first movable contact 461 of the third relay 46 is connected to a common connection terminal of the first relay 44 and the second relay 45 through a wire, realizing conduction with a subsequent circuit. The first L1 contact 4621 is electrically connected to both a live wire terminal of the single-phase alternating-current input interface 121 and an L1 live wire terminal of the split-phase alternating-current input interface 122 through wires. The first L2 contact 4622 is electrically connected to an L2 live wire terminal of the split-phase alternating-current input interface 122 through a wire. The first neutral contact 4623 is electrically connected to both a neutral wire terminal of the single-phase alternating-current input interface 121 and a neutral wire terminal of the split-phase alternating-current input interface 122 through wires. The first ground contact 4624 is electrically connected to both a ground wire terminal of the single-phase alternating-current input interface 121 and a ground wire terminal of the split-phase alternating-current input interface 122 through wires.

Specifically, when a household adopts the single-phase utility power, the first movable contact 461 of the third relay 46 engages with the first L1 contact 4621, the first neutral contact 4623, and the first ground contact 4624, realizing access of the single-phase utility power. When the household uses the split-phase utility power, the first movable contact 461 of the third relay 46 engages with all the stationary contacts, realizing complete access of the L1 and L2 live wires as well as the neutral wire and the ground wire.

Referring to FIG. 3, in some embodiments, the utility power socket 200 includes a single-phase utility power socket 210 and a split-phase utility power socket 220. The first pluggable connector 60 includes a single-phase input wire 61 and a split-phase input wire 62. The single-phase input wire 61 includes a single-phase input plug 611 and a single-phase output plug 612. The single-phase input plug 611 is configured to be in a pluggable connection with the single-phase utility power socket 210. The single-phase output plug 612 is configured to be in a pluggable connection with the single-phase alternating-current input interface 121. The split-phase input wire 62 includes a split-phase input plug 621 and a split-phase output plug 622. The split-phase input plug 621 is configured to be in a pluggable connection with the split-phase utility power socket 220. The split-phase output plug 622 is configured to be in a pluggable connection with the split-phase alternating-current input interface 122.

In this way, the alternating-current input interface 12 can be connected to the utility power through the single-phase input wire 61 or the split-phase input wire 62, enabling the energy storage power supply 100 to serve as a backup power source for both the single-phase utility power and the split-phase utility power.

Specifically, in the embodiment of the present disclosure, the utility power socket 200 includes a single-phase utility power socket 210 and a split-phase utility power socket 220 that are commonly used in households. The single-phase utility power socket 210 is a standard three-hole socket with a rated voltage of 120V. The split-phase utility power socket 220 is a dedicated socket adapted for split-phase power supply, and is provided with L1 and L2 live wire insertion holes as well as neutral and ground wire insertion holes. The split-phase utility power socket 220 has a rated voltage set based on a regional standard, such as a 240V split-phase voltage in North America.

In some embodiments, the first pluggable connector 60 includes two types of specifications: the single-phase input wire 61 and the split-phase input wire 62. Structures of the two input wires are basically the same. Specifically, the single-phase input plug 611 of the single-phase input wire 61 is a standard three-hole plug, corresponding to an insertion hole layout of the single-phase utility power socket 210. The single-phase output plug 612 is a three-hole socket, corresponding to the single-phase alternating-current input interface 121 of the energy storage power supply 100. The split-phase input plug 621 of the split-phase input wire 62 is a multi-hole plug, matching an insertion hole layout of the split-phase utility power socket 220. The split-phase output plug 622 is a multi-hole socket, matching the split-phase alternating-current input interface 122 of the energy storage power supply 100.

Referring to FIG. 3, in some embodiments, the alternating-current output interface 13 includes a single-phase alternating-current output interface 131 and a split-phase alternating-current output interface 132. The backup power device 300 includes a power receiving socket 320. The power receiving socket 320 includes a single-phase power receiving socket 321 and a split-phase power receiving socket 322. The second pluggable connector 70 includes a single-phase output wire 71 and a split-phase output wire 72. The single-phase output wire 71 is configured to be in a pluggable connection with the single-phase alternating-current output interface 131 and the single-phase power receiving socket 321. The split-phase output wire 72 is configured to be in a pluggable connection with the split-phase alternating-current output interface 132 and the split-phase power receiving socket 322.

In some embodiments, a maximum overcurrent value of each of the single-phase alternating-current input interface 121 and the single-phase input wire 61 is 30 A. A maximum overcurrent value of each of the split-phase alternating-current input interface 122 and the split-phase input wire 62 is 50 A, 80 A, 100 A, 120 A, 150 A, or 200 A.

In this way, the input wires equipped for the energy storage power supply 100 possess a strong overcurrent capability, which is conducive to adapting to a larger load.

Specifically, in the embodiment of the present disclosure, the maximum overcurrent value of each of the single-phase alternating-current input interface 121 and the single-phase input wire 61 is set to 30 A. The maximum overcurrent value of each of the split-phase alternating-current input interface 122 and the input wire is set to have various specifications, including 50 A, 80 A, 100 A, 120 A, 150 A, or 200 A. For example, a 30A single-phase input wire 61 may satisfy a power supply requirement of a single-phase load (such as a refrigerator, a washing machine, or an air conditioner) with rated power of smaller than 6 kW. A 50 A split-phase input wire 62 may satisfy a requirement of a split-phase load with rated power of smaller than 12 kW. A split-phase input wire 62 of 100 A or above may be adapted to a high-power household electrical appliance (such as an electric water heater or an oven) or a scenario where a plurality of loads operate simultaneously. This multi-specification overcurrent capability design enables the energy storage power supply 100 to be flexibly configured based on the actual power requirement of the household load, avoiding component damage or power interruption caused by insufficient overcurrent capability. Furthermore, market applicability of the product is improved, satisfying personalized needs of different households.

Referring to FIG. 1 and FIG. 5, in some embodiments, the alternating-current output interface 13 includes a single-phase alternating-current output interface 131 and a split-phase alternating-current output interface 132. The second relay 45 includes a second movable contact 451 and a second stationary contact 452. The second movable contact 451 is connected to both the first relay 44 and the third relay 46. The second stationary contact 452 includes a second L1 contact 4521, a second L2 contact 4522, a second neutral contact 4523, and a second ground contact 4524. The second L1 contact 4521 is connected to both a live wire of the single-phase alternating-current output interface 131 and an L1 live wire of the split-phase alternating-current output interface 132. The second L2 contact 4522 is connected to an L2 live wire of the split-phase alternating-current output interface 132. The second neutral contact 4523 is connected to both a neutral wire of the single-phase alternating-current output interface 131 and a neutral wire of the split-phase alternating-current output interface 132. The second ground contact 4524 is connected to both a ground wire of the single-phase alternating-current output interface 131 and a ground wire of the split-phase alternating-current output interface 132.

In this way, by specifically defining the wiring modes of the single-phase alternating-current output interface 131 and the split-phase alternating-current output interface 132, flexible adaptation to single-phase and split-phase devices is realized, which facilitates application to different types of devices.

Specifically, in the embodiment of the present disclosure, the alternating-current output interface 13 is also integrated on an interface panel of the housing 10 of the energy storage power supply 100, is arranged adjacent to the alternating-current input interface 12, and includes the single-phase alternating-current output interface 131 and the split-phase alternating-current output interface 132. The single-phase alternating-current output interface 131 is a standard three-hole socket structure. The split-phase alternating-current output interface 131 is a multi-hole structure, and is provided with L1 and L2 live wire insertion holes as well as neutral and ground wire insertion holes, adapting to a power supply requirement of a split-phase load.

In the embodiment of the present disclosure, the second movable contact 451 of the second relay 45 is connected to a common connection terminal of the first relay 44 and the third relay 46 through a wire, realizing conduction with a preceding circuit. The second L1 contact 4521 is electrically connected to both a live wire terminal of the single-phase alternating-current output interface 131 and an L1 live wire terminal of the split-phase alternating-current output interface 132 through wires. The second L2 contact 4522 is electrically connected to an L2 live wire terminal of the split-phase alternating-current output interface 132 through a wire. The second neutral contact 4523 is electrically connected to both a neutral wire terminal of the single-phase alternating-current output interface 131 and a neutral wire terminal of the split-phase alternating-current output interface 132 through wires. The second ground contact 4524 is electrically connected to both a ground wire terminal of the single-phase alternating-current output interface 131 and a ground wire terminal of the split-phase alternating-current output interface 132 through wires.

In the embodiment of the present disclosure, when power is supplied to the single-phase load, the user may insert the second pluggable connector 70 into the single-phase alternating-current output interface 13, and the controller 31 controls the second movable contact 451 of the second relay 45 to be engaged with the second L1 contact 4521, the second neutral contact 4523, and the second ground contact 4524, thereby realizing output of a single-phase alternating current. When power is supplied to the split-phase load, the second pluggable connector 70 is inserted into the split-phase alternating-current output interface 13, and the controller 31 controls the second movable contact 451 of the second relay 45 to be engaged with all the stationary contacts, thereby realizing complete output of a split-phase alternating current.

In some embodiments, a maximum overcurrent value of the alternating-current input interface 12 is 30 A, 50 A, 80 A, 100 A, 150 A, or 200 A.

In this way, the alternating-current input interface 12 equipped for the energy storage power supply 100 possesses a strong overcurrent capability, which is conducive to adapting to a larger load.

In some embodiments, the maximum overcurrent value of the alternating-current input interface 12 is set to have various specifications, including 30 A, 50 A, 80 A, 100 A, 150 A, or 200 A, and interfaces of different specifications correspond to different internal structures. The alternating-current input interface 12 has a strong overcurrent capability and may be adapted to utility power access requirements of different powers.

For example, an alternating-current input interface 12 of a 30 A specification is suitable for a small-power household load scenario, and may satisfy a total power requirement of a daily household appliance (such as a refrigerator, a television, or a computer). An alternating-current input interface 12 of a 50 A to 80 A specification is suitable for a medium-power scenario, and may be adapted to a high-power single load such as an air conditioner or an electric water heater or the scenario where the plurality of loads operate simultaneously. An alternating-current input interface 12 of a 100 A or higher specification is suitable for a high-power split-phase load scenario, and may satisfy a requirement for simultaneous operation of a plurality of high-power devices in a large household such as a villa.

In some embodiments, a maximum overcurrent value of the transfer switch circuit 40 is 30 A, 50 A, 80 A, 100 A, 150 A, or 200 A.

In this way, the transfer switch circuit 40 of the energy storage power supply 100 possesses a strong overcurrent capability, which is conducive to adapting to a larger load.

Specifically, in some embodiments, the maximum overcurrent value of the transfer switch circuit 40 is set to have various specifications such as 30 A, 50 A, 80 A, 100 A, 150 A, or 200 A. For example, a transfer switch circuit 40 of a 30 A specification uses a relay with a rated current of 30 A. A transfer switch circuit 40 of a 50 A specification uses a relay with a rated current of 50 A. A transfer switch circuit 40 of a 100 A or higher specification uses a contactor instead of the relay. In this way, it is ensured that current carrying capabilities of the components are the same, avoiding some components in local region from becoming an overcurrent bottleneck.

In some embodiments, the maximum overcurrent value of the alternating-current output interface 13 is 30 A, 50 A, 80 A, 100 A, 150 A, or 200 A.

In this way, the alternating-current output interface 13 equipped for the energy storage power supply 100 possesses a strong overcurrent capability, which is conducive to adapting to a larger load.

Specifically, in some embodiments, the maximum overcurrent value of the alternating-current output interface 13 matches overcurrent specifications of the alternating-current input interface 12 and the transfer switch circuit 40, and is also set to have various specifications such as 30 A, 50 A, 80 A, 100 A, 150 A, or 200 A.

In some embodiments, the alternating-current output interface 13 possesses a strong overcurrent capability and may be adapted to household loads of different powers. For example, an alternating-current output interface 13 of a 30 A specification may meet power supply requirements of daily small-and-medium-power household appliances. An alternating-current output interface 13 of a 50 A to 80 A specification may be adapted to a high-power load such as an air conditioner or an electric water heater. An alternating-current output interface 13 with a 100 A or higher specification may meet the requirement for the simultaneous operation of the plurality of high-power devices in a large household such as a villa.

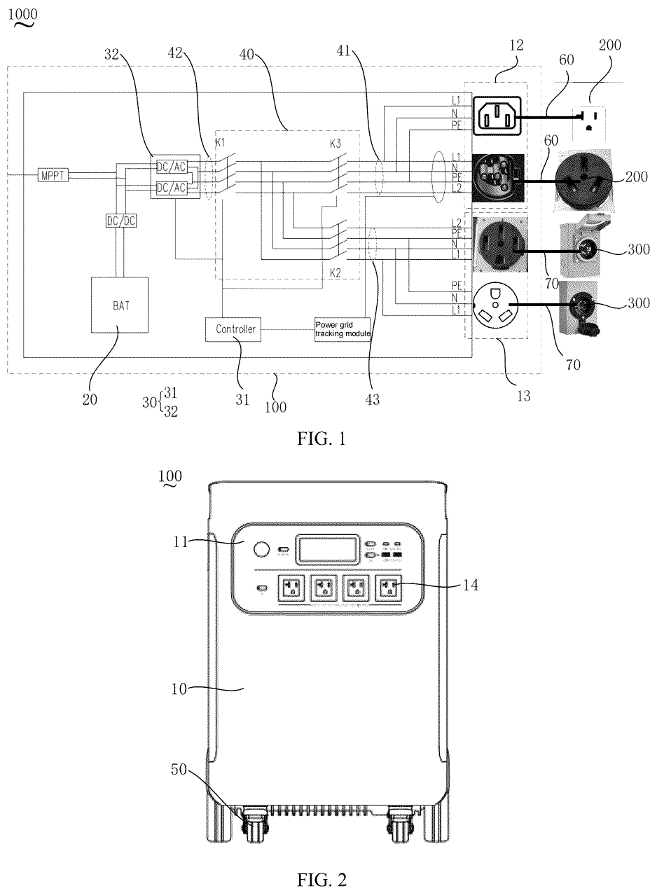

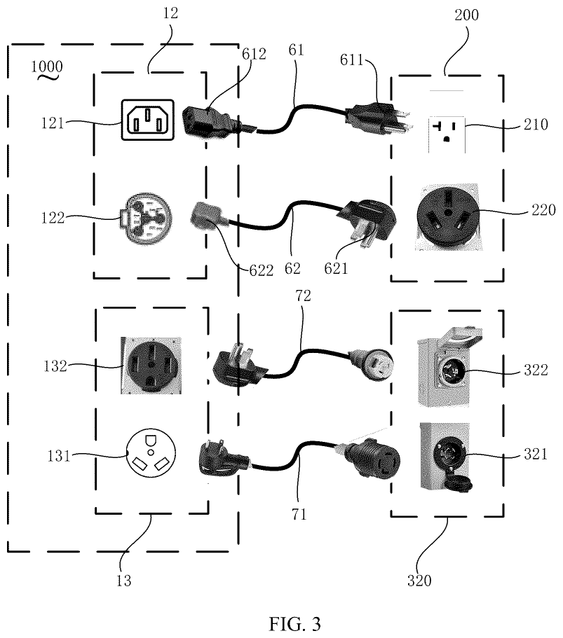

Referring to FIG. 2, in some embodiments, the energy storage power supply 100 includes a socket panel 11 provided with a plurality of alternating-current (AC) sockets 14.

In this way, by disposing the AC sockets 14 on the socket panel 11 of the housing 10, it is convenient for the user to quickly connect the load, improving convenience of mounting and use.

Specifically, in the embodiment of the present disclosure, by disposing the socket panel 11 integrated with the plurality of AC sockets 14 on the energy storage power supply 100, the layout of the interfaces adopts a matrix or linear arrangement, ensuring that sufficient plugging and unplugging space is reserved between the interfaces to avoid mutual interference between adjacent plugs.

In the embodiment of the present disclosure, the socket panel 11 is fixed to the housing 10 of the energy storage power supply 100 through bolts, and the sealing rubber ring is disposed between the panel and the housing 10 to improve the dustproof and waterproof performance. A surface of the panel is printed with a clear interface identifier to facilitate user identification.

In the embodiment of the present disclosure, by integrating a plurality of alternating-current output interfaces 13 on the socket panel 11, the user may connect a plurality of household loads simultaneously without the need to additionally use a power strip, reducing wire clutter and improving tidiness of use. Meanwhile, the integrated layout centralizes the arrangement of interface positions, so that the user does not need to search for scattered interfaces on the housing 10, making mounting and use more convenient. For example, the user may insert plugs of core loads such as a refrigerator, a television, and a computer into different interfaces of the socket panel 11, achieving the connection of all loads at one time, which greatly simplifies the mounting process. In addition, an independent design of the socket panel 11 also facilitates later maintenance. When a certain interface fails, the panel may be disassembled individually for repair or replacement without disassembling the entire energy storage power supply 100, reducing the maintenance cost.

Referring to FIG. 2, in some embodiments, the energy storage power supply 100 includes a traveling wheel 50. The housing 10 is disposed on the traveling wheel 50.

In this way, by mounting the housing 10 on the traveling wheel 50, it is convenient to move the energy storage power supply 100, which is conducive to improving portability of the energy storage power supply 100.

Specifically, in the embodiment of the present disclosure, the portability of the product is improved by disposing the traveling wheel 50 on the housing 10 of the energy storage power supply 100, facilitating the user to flexibly move the energy storage power supply 100 based on the load position or use requirements. Specifically, the number of traveling wheels 50 is four. The four traveling wheels 50 are distributed in a rectangular shape at four corners of a bottom of the housing 10 to ensure stable support. Each traveling wheel 50 is connected to the housing 10 through a support, and the support is connected to a mounting base at the bottom of the housing 10 through bolts. A ball bearing is provided inside a wheel body of the traveling wheel 50 to reduce rolling resistance.

In some embodiments, the single-phase alternating-current input interface 121 is a standard flat-blade conventional socket. This interface is suitable for accessing the most common single-phase utility power to perform routine charging for an energy storage unit inside the device.

In some embodiments, the split-phase alternating-current input interface 122 is a NEMA 14-50 specification socket. This interface can be used to access a split-phase alternating current (e.g., 240V split-phase) providing higher power, to realize fast charging for the energy storage unit.

In some embodiments, the single-phase alternating-current output interface 131 is a NEMA L14-30R specification socket. This interface is a locking connector capable of providing single-phase alternating-current output at a 30-ampere level, with a stable and reliable connection, and is suitable for driving a single-phase high-power load, such as an electric saw or a large lighting device.

In some embodiments, the split-phase alternating-current output interface 132 is a NEMA 14-50 specification socket. This interface can provide complete split-phase alternating-current output, and is capable of supplying power to a dedicated device requiring 240V voltage (such as a large welding machine or an electric vehicle charging adapter).

In some embodiments, the socket panel 11 is integrated with at least one AC socket 14 that includes a NEMA 5-20 specification socket. This interface is of a standard household socket specification, used to provide a convenient 120V alternating-current power supply for various common low-voltage single-phase electrical devices (such as a laptop, a lamp, and a small household appliance), and is also used to be carried outdoors for use by an outdoor camping electrical device or an outdoor operation electrical device. In some embodiments, the AC socket 14 may also include a single-phase socket and/or a split-phase socket. The single-phase socket or the split-phase socket can be used to be electrically connected to the backup power device (e.g., MTS), and supply power to a load connected to the backup power device.

In some embodiments, a part of the traveling wheel 50 may further be provided with a braking device. The braking device includes a brake pedal and a brake pad. Stepping on the brake pedal can allow the brake pad to be in close contact with the wheel body, realizing fixation of the energy storage power supply 100 and preventing accidental movement.

In some embodiments, the traveling wheel 50 is detachably mounted on the housing 10 of the energy storage power supply 100, to facilitate later maintenance and replacement. When the wheel body is worn or the bearing is damaged, the traveling wheel 50 may be disassembled and replaced individually without replacing the entire housing 10, reducing the maintenance cost.

In the description of this specification, descriptions with reference to the terms “some implementations”, “an implementation”, “some embodiments”, “illustrative embodiments”, “examples”, “specific examples”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality of” means at least two, such as two, three, etc., unless otherwise specifically defined.

Although embodiments according to the present disclosure have been shown and described, it would be appreciated by those skilled in the art that the above embodiments are illustrative and cannot be construed as a limitation on the present disclosure, and changes, alternatives, modifications, and variations can be made in the embodiments without departing from scope of the present disclosure.

What is claimed is:

1. An energy storage power supply, comprising:
a housing;
an alternating-current input interface and an alternating-current output interface that are formed at the housing, wherein the alternating-current input interface is configured to be in a pluggable connection with a utility power socket through a first pluggable connector, the utility power socket being connected to utility power, and wherein the alternating-current output interface is configured to be in a pluggable connection with a backup power device through a second pluggable connector, the backup power device being configured to be connected to an alternating-current load; and
a battery pack, an inverter, a controller, and a transfer switch circuit that are disposed in the housing, wherein the transfer switch circuit comprises a utility power input terminal, an inverter alternating-current terminal, and a load output terminal, wherein:
the utility power input terminal is connected to the alternating-current input interface, the inverter alternating-current terminal is connected to the battery pack through the inverter, and the load output terminal is connected to the alternating-current output interface; and
the controller is configured to:
monitor utility power voltage information at the utility power input terminal;
control, in response to the utility power voltage information being normal, the transfer switch circuit to enable a connection between the utility power input terminal and the load output terminal, to cause the utility power, after passing through the alternating-current input interface and the alternating-current output interface, to supply power to the alternating-current load connected to the backup power device; and
control, in response to the utility power voltage information being abnormal, the transfer switch circuit to enable a connection between the inverter alternating-current terminal and the load output terminal, to cause the battery pack, after DC power from the battery pack being inverted to AC power by the inverter, to supply power to the alternating-current load connected to the backup power device.

2. The energy storage power supply according to claim 1, wherein the backup power device comprises a manual transfer switch backup power device, and the alternating-current output interface is configured to be in a pluggable connection with a power receiving socket of the manual transfer switch backup power device through the second pluggable connector.

3. The energy storage power supply according to claim 1, wherein:
the inverter comprises a bidirectional alternating-current/direct-current converter and a controller connected to the bidirectional alternating-current/direct-current converter; and
the transfer switch circuit comprises a first relay, a second relay, and a third relay, wherein:
the utility power input terminal is connected to the bidirectional alternating-current/direct-current converter sequentially through the third relay and the first relay;
the load output terminal is connected to the bidirectional alternating-current/direct-current converter sequentially through the second relay and the first relay; and
the controller is connected to the first relay, the second relay, and the third relay, and is configured to control closing and opening of each of the first relay, the second relay, and the third relay.

4. The energy storage power supply according to claim 3, wherein the controller is further configured to control, in response to a utility power voltage being abnormal or a first predetermined condition being satisfied, the first relay and the second relay to be closed and the third relay to be opened, wherein the first predetermined condition comprises that a current time period falls within a peak power consumption period of the utility power and that a state of charge (SOC) of the battery pack is greater than or equal to a first predetermined value.

5. The energy storage power supply according to claim 4, wherein the controller is further configured to control, in response to a second predetermined condition being satisfied, the first relay, the second relay, and the third relay to be closed, to cause the battery pack and the utility power to supply power to the alternating-current load simultaneously, wherein the second predetermined condition comprises that the current time period falls within the peak power consumption period of the utility power and that the SOC of the battery pack is greater than a second predetermined value and smaller than the first predetermined value.

6. The energy storage power supply according to claim 5, wherein the controller is further configured to obtain a voltage phase, an amplitude, and a frequency of the utility power, and control a phase difference between an output voltage of the bidirectional alternating-current/direct-current converter and the utility power voltage not to exceed ±2°, an amplitude difference between the output voltage of the bidirectional alternating-current/direct-current converter and the utility power voltage not to exceed ±10%, and a frequency difference between the output voltage of the bidirectional alternating-current/direct-current converter and the utility power voltage not to exceed ±0.5 Hz.

7. The energy storage power supply according to claim 5, wherein the controller is further configured to obtain a voltage phase of the utility power and control a phase of an output voltage of the bidirectional alternating-current/direct-current converter to lag the voltage phase of the utility power by a predetermined difference.

8. The energy storage power supply according to claim 4, wherein the controller is in communication with the bidirectional alternating-current/direct-current converter and configured to control output power and/or input power of the bidirectional alternating-current/direct-current converter.

9. The energy storage power supply according to claim 3, wherein the controller is further configured to control, in response to a current time period falling within a valley power consumption period of the utility power, the first relay, the second relay, and the third relay to be closed, to cause the utility power to supply power to the battery pack and the alternating-current load simultaneously.

10. The energy storage power supply according to claim 9, wherein the controller is in communication with the bidirectional alternating-current/direct-current converter, and further configured to control input power of the bidirectional alternating-current/direct-current converter based on required power of the load.

11. The energy storage power supply according to claim 3, wherein the alternating-current input interface comprises a single-phase alternating-current input interface and a split-phase alternating-current input interface, and the third relay comprises a first movable contact and a first stationary contact, wherein:
the first movable contact is connected to both the first relay and the second relay;
the first stationary contact comprises a first L1 contact, a first L2 contact, a first neutral contact, and a first ground contact;
the first L1 contact is connected to both a live wire of the single-phase alternating-current input interface and an L1 live wire of the split-phase alternating-current input interface;
the first L2 contact is connected to an L2 live wire of the split-phase alternating-current input interface;
the first neutral contact is connected to both a neutral wire of the single-phase alternating-current input interface and a neutral wire of the split-phase alternating-current input interface; and
the first ground contact is connected to both a ground wire of the single-phase alternating-current input interface and a ground wire of the split-phase alternating-current input interface.

12. The energy storage power supply according to claim 11, wherein the utility power socket comprises a single-phase utility power socket and a split-phase utility power socket, and the first pluggable connector comprises a single-phase input wire and a split-phase input wire, wherein:
the single-phase input wire comprises a single-phase input plug and a single-phase output plug;
the single-phase input plug is configured to be in a pluggable connection with the single-phase utility power socket;
the single-phase output plug is configured to be in a pluggable connection with the single-phase alternating-current input interface;
the split-phase input wire comprises a split-phase input plug and a split-phase output plug;
the split-phase input plug is configured to be in a pluggable connection with the split-phase utility power socket; and
the split-phase output plug is configured to be in a pluggable connection with the split-phase alternating-current input interface.

13. The energy storage power supply according to claim 12, wherein:
a maximum overcurrent value of each of the single-phase alternating-current input interface and the single-phase input wire is 30 A; and
a maximum overcurrent value of each of the split-phase alternating-current input interface and the split-phase input wire is 50 A, 80 A, 100 A, 120 A, 150 A, or 200 A.

14. The energy storage power supply according to claim 3, wherein the alternating-current output interface comprises a single-phase alternating-current output interface and a split-phase alternating-current output interface, and the second relay comprises a second movable contact and a second stationary contact, wherein:
the second movable contact is connected to both the first relay and the third relay;
the second stationary contact comprises a second L1 contact, a second L2 contact, a second neutral contact, and a second ground contact;
the second L1 contact is connected to both a live wire of the single-phase alternating-current output interface and an L1 live wire of the split-phase alternating-current output interface;
the second L2 contact is connected to an L2 live wire of the split-phase alternating-current output interface;
the second neutral contact is connected to both a neutral wire of the single-phase alternating-current output interface and a neutral wire of the split-phase alternating-current output interface; and
the second ground contact is connected to both a ground wire of the single-phase alternating-current output interface and a ground wire of the split-phase alternating-current output interface.

15. The energy storage power supply according to claim 1, wherein a maximum overcurrent value of the transfer switch circuit is 30 A, 50 A, 80 A, 100 A, 150 A, or 200 A.

16. The energy storage power supply according to claim 1, wherein a maximum overcurrent value of each of the alternating-current input interface and the alternating-current output interface is 30 A, 50 A, 80 A, 100 A, 150 A, or 200 A.

17. The energy storage power supply according to claim 1, comprising:
a socket panel disposed at the housing, the socket panel comprising a plurality of AC sockets.

18. The energy storage power supply according to claim 1, comprising:
a traveling wheel, wherein the housing is disposed on the traveling wheel.

19. A household load backup power system, comprising:
the energy storage power supply according to claim 1; and
a manual transfer switch backup power device, wherein a power receiving socket of the manual transfer switch backup power device is in a pluggable connection with an alternating-current output interface of the energy storage power supply through a second pluggable connector.

20. The household load backup power system according to claim 19, wherein the manual transfer switch backup power device comprises a power supply selection switch, wherein the power supply selection switch comprises a backup-power supply operation position and is configured to be in the backup-power supply operation position by default to enable a connection between the energy storage power supply and the backup power device.
